(19) United States
(12) Patent Application Publication
(10) Pub. No.: US 2019/0351743 A1
(43) Pub. Date: Nov. 21, 2019

(54) COMPACT REAR VEHICLE HVAC STRUCTURE

(71) Applicant: Calsonic Kansei North America, Inc., Farmington Hills, MI (US)

(72) Inventors: Silvia Denisse Vazquez Salazar, Farmington Hills, MI (US); Scott Torok, Farmington Hills, MI (US)

(21) Appl. No.: 15/980,044

(22) Filed: May 15, 2018

(51) Int. Cl. B60H 1/32; B60H 1/00

(52) U.S. Cl. CPC B60H 1/3233; B60H 1/3227; B60H 1/3229; B60H 1/00564

(57) ABSTRACT

A rear vehicle HVAC system includes an evaporator, a blower disposed above the evaporator, and a duct passing next to the blower, the duct connecting the evaporator and an outlet opening. The duct is approximately vertical, and a width of the system proximate a lower end of the duct is narrower than a width of the system proximate the blower.

### BACKGROUND

The present application relates generally to the field of heating, ventilation, and air conditioning (“HVAC”) systems for vehicles.

A conventional HVAC system is large and is typically installed in an engine compartment of a vehicle, which is capable of accommodating the large size without interfering with passenger space. While many vehicles only provide vents for providing air directly to a front row of seats, some vehicles include vents for providing air directly to passengers in a second or third row in the vehicle. In one example, these vents may be positioned in a rear side of a center console of the vehicle. In this configuration, ducts connecting the HVAC system to the vents may be installed in or around the center console, transmission tunnel, or the floor of the vehicle, taking up usable space and reducing overall passenger space in the vehicle. Furthermore, these vents are generally positioned low in the vehicle space and cannot blow air directly on a passenger's face for the most effective cooling sensation.

In another example, the vents may be positioned in a vehicle's headliner or door pillars. In each of these configurations, the ducts connecting the HVAC system to the vents may be installed in the vehicle's headliner. The space required for the ducts in the headliner reduces headroom available in the vehicle. Furthermore, because the ducts must be connected from the rear passenger compartment all the way to the HVAC system in the engine compartment, excess ducting is required, increasing material cost and complicating the installation of the HVAC system during vehicle assembly. In addition, friction losses over longer distances reduces the air speed at the vents further away from the front passenger compartment, thereby reducing HVAC system efficiency and providing less cooling for rear passengers.

It would therefore be advantageous to provide a compact HVAC system disposed in or proximate a rear wheel well of a vehicle, which provides cooling directly to rear passengers in the vehicle. It would further be advantageous to connect the HVAC system to a vent in a rear door of the vehicle to be able to blow air directly on a passenger's face, while not infringing on passenger space in the vehicle.

### SUMMARY

One embodiment relates to a vehicle HVAC system, including an evaporator, a blower disposed above the evaporator, and a duct passing next to the blower, the duct connecting the evaporator and an outlet opening. The duct is approximately vertical, and a width of the system proximate a lower end of the duct is narrower than a width of the system proximate the blower.

Another embodiment relates to a housing for a vehicle HVAC system, including a blower portion defined by a blower wall and configured to receive a blower therein along a blower axis, the blower portion defining a blower width. The housing further includes a first duct extending downstream from the blower portion and a second duct extending downstream from the first duct and defining an inner wall and an opposing outer wall. The housing further includes an inner bulge extending from the inner wall and defining a step. The inner wall of the second duct extends tangentially to the blower wall along a tangential axis, and the inner bulge extends away from the tangential axis and toward the blower wall.

### BRIEF DESCRIPTION OF THE DRAWINGS

FIG. 1 is a perspective view of an HVAC system, according to an exemplary embodiment.

FIG. 2 is a cross-sectional view of the HVAC system of FIG. 1, with a door in a closed position.

FIG. 3 shows the view of FIG. 2, with the door in an open position.

FIG. 4 is a close-up view of section 4-4 in FIG. 1.

### DETAILED DESCRIPTION

Referring to the FIGURES generally, an HVAC system for a vehicle is shown according to various exemplary embodiments. It should be noted that the HVAC system as shown is configured as an air conditioner without a heater, but that the term “HVAC system” is being used to refer generally to systems which deliver air in a vehicle and are configured to control the temperature of the air. Further it should be understood that the HVAC system may be configured as a heater without an evaporator or with both a heater and an evaporator according to various exemplary embodiments.

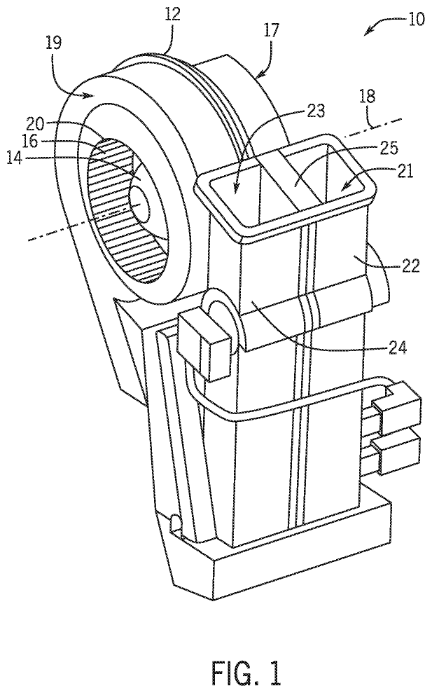

Referring now to FIG. 1, the HVAC system 10 (hereinafter the “system”) is shown according to an exemplary embodiment. The system 10 defines a housing 12 (i.e., case, shell, body, etc.) and a blower 14 disposed within the housing 12. The blower 14 includes an electric motor coupled to a fan cage 16 having a plurality of blades arranged in a cylindrical orientation and configured to rotate about a blower axis 18. The housing 12 is formed from at least two components, including a first (i.e., lower, rear, etc.) body 22 and a second (i.e., upper, forward, etc.) body 24 disposed on and engaging the first body 22. According to an exemplary embodiment, corresponding edges of the first body 22 and the second body 24 may define substantially the same outer profile, such that the edges are configured to align and/or mate with each other. A blower inlet 20 is defined in the second body 24 and is configured to correspond to (e.g., be substantially aligned with) the fan cage 16, such that the blower inlet 20 defines a substantially circular profile annularly formed about the blower axis 18.

During assembly of the system 10, the blower 14 may be disposed in the first body 22 with the fan cage 16 facing outward from the first body 22 toward the second body 24. The second body 24 is then aligned with the first body 22, such that the blower inlet 20 is aligned with the fan cage 16 and the second body 24 is positioned against and coupled to the first body 22. The blower inlet 20 defines a blower inlet diameter that is less than a fan cage outer diameter, such that the fan cage 16 cannot pass through the blower inlet 20. In this configuration, the second body 24 may retain the fan cage 16 within the housing 12. According to an exemplary embodiment, the blower inlet diameter may be substantially the same as or less than a fan cage inner diameter, such that the blades are concealed from view when viewing the blower inlet 20 along the blower axis 18.

When the system 10 is in operation, the blower 14 cause the fan cage 16 to rotate within the housing 12, about the blower axis 18. Blades in the fan cage 16 draw air external to the housing 12, through the blower inlet 20 and into the housing 12 for cooling and passing through ducts, as will be discussed in further detail below. The volume flow rate of air in the system 10 may be controlled by adjusting the rotational speed of the blower 14. For example, as the blower 14 increases in speed, the fan cage 16 draws more air into the housing 12, and as the blower 14 decreases in speed, the fan cage 16 draws less air into the housing 12.

Referring still to FIG. 1, the system 10 is shown as a multi-zone system 10 (e.g., with two zones). In this configuration, at least a first conduit 21 is defined by the first body 22 and a second conduit 23 is defined by the second body 24 and separated from the first conduit 21 with a partition 25 disposed therebetween. While the blower 14 operates, air is provided to each of the conduits 21, 23 at the same volume flow rate and may be separately controlled in each conduit 21, 23 further downstream, as will be discussed in further detail below. It should be noted that while FIG. 1 shows a two-zone system 10, according to other exemplary embodiments, the system 10 may include more or fewer zones and therefore more or fewer conduits 21, 23 separated by partitions 25.

As shown in FIG. 1, the first body 22 defines a first end surface 17 and the second body 24 defines a second end surface 19 opposing the first end surface 17. The blower inlet 20 is formed in the second end surface 19 and the blower axis 18 is configured to extend substantially perpendicular to one or both of the first and second end surfaces 17, 19. Further, the first and second end surfaces 17, 19 may extend substantially parallel to the partition 25. In this configuration, a distance between the first and second end surfaces 17, 19 proximate the first conduit 21 and/or the second conduit 23 may be substantially the same as or less than a distance between the first and second end surfaces 17, 19 proximate the blower 14.

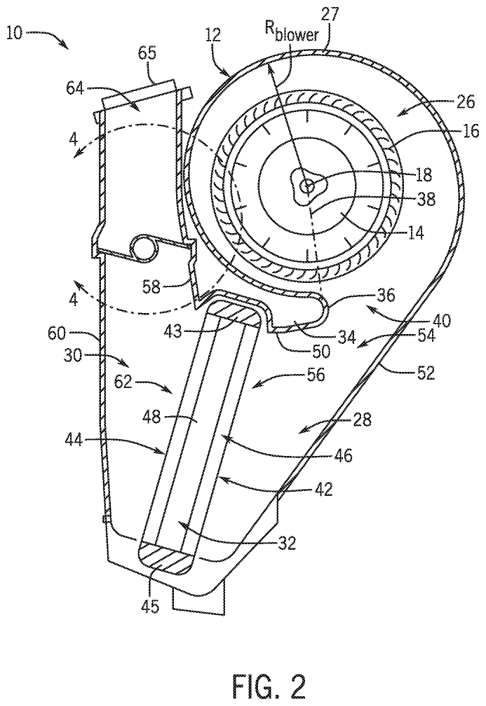

Referring now to FIG. 2, a cross-sectional view of the system 10 is shown according to an exemplary embodiment. The housing 12 includes a blower portion 26 (i.e., a first housing portion), a first duct 28 (i.e., an upstream duct, a second housing portion, etc.), a second duct 30 (i.e., a downstream duct, a third housing portion, etc.), and an evaporator 32 disposed below the blower portion 26, between the first duct 28 and the second duct 30. The blower portion 26 is configured to house the blower 14 therein and includes a blower wall 27 formed annularly about the blower 14. The blower wall 27 includes a tongue 34, which extends circumferentially about the blower 14 and defines a tongue end 36 approximately directly vertically below the blower axis 18 (e.g., along an axis 38 extending vertically downward from the blower axis 18). A blower outlet 40 is defined between the tongue end 36 and an opposing portion of the blower wall 27.

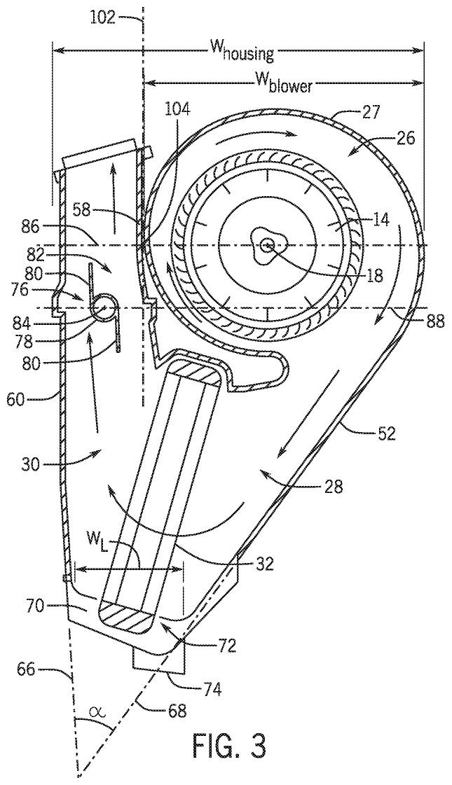

The blower wall 27 defines a substantially spiral outer profile measured about the blower axis 18. Specifically, a blower portion radius R_{blower}, measured from the blower axis 18 to the blower wall 27 increases moving circumferentially about the blower axis 18 from the tongue end 36, fully long-ways (e.g., in a clockwise direction in the configuration shown in FIG. 2) around the blower 14 to the blower outlet 40. As the blower portion radius R_{blower} increases, a cross-sectional area measured between the blower axis 18 and the blower wall 27, taken along the blower portion radius R_{blower}, also increases. As shown in FIG. 3, as the cross-sectional area increases, the localized pressure decreases, generating a stream line of air with a flow direction from the higher pressure region proximate the tongue end 36, circumferentially about the blower 14, and downstream toward the blower outlet 40.

It should be noted that while FIG. 2 shows the blower portion radius R_{blower} increasing in the clockwise direction, according to other exemplary embodiments, the blower portion radius R_{blower} may increase moving circumferentially counterclockwise about the blower axis 18 or may be substantially constant, such that the blower 14 is centered within the blower wall 27. According to other exemplary embodiments the blower portion radius R_{blower} may vary in other ways about the blower axis 18.

Referring still to FIG. 2, the first duct 28 extends downstream from the blower outlet 40 toward the evaporator 32. The evaporator 32 defines a first side 42 (i.e., inlet side, upstream side, etc.) proximate the first duct 28, an opposing second side 44 (i.e., outlet side, downstream side, etc.), and an opening 46 extending from the first side 42 to the second side 44. The evaporator 32 further defines an upper end 43 extending into the tongue 34 and an opposing lower end 45. A plurality of cooling lines 48 (i.e., fins, vanes, etc.) are disposed in the opening 46 and are configured to pass a refrigerant therethrough. During operation of the system 10 air is pushed from the blower portion 26, through the first duct 28, and fed to the opening 46 in the evaporator 32. As the air passes through the opening 46 along the cooling lines 48, heat is transferred from the air, through the cooling lines 48 and to the refrigerant, which evaporates from a liquid state to a gas state. As heat is transferred from the air, the temperature of the air decreases and cooled air is output from the opening 46 at the second side 44 of the evaporator 32, into the second duct 30. It should be recognized that while FIGS. 2 and 3 show the system 10 with an evaporator 32 disposed between the first duct 28 and the second duct 30, according to other exemplary embodiments, the evaporator 32 may be a heater for heating the air from the first duct 28. In this configuration, the cooling lines 48 are heating coils configured to transfer heat from the heater to the air passing along the heating coils, thereby increasing the temperature of the air output from the heater. According to yet another exemplary embodiment, the system 10 may include a heater in addition to the evaporator 32. In this configuration, the heater is provided in the housing 12 such that the outer profile of the housing 12 does not increase in size, thereby maintaining the housing's 12 compact configuration.

The first duct 28 includes an inner wall 50, forming a portion of the tongue 34 at an interior portion of the housing 12, and an opposing outer wall 52. The first duct 28 further defines a first end 54 (i.e., inlet end, upstream end, etc.) proximate the blower outlet 40 and an opposing second end 56 (i.e., outlet end, downstream end, etc.) proximate the first side 42 of the evaporator 32. A cross-sectional shape and area of the first duct 28 at the first end 54 corresponds to (e.g., is substantially the same as) the cross-sectional shape and area of the blower outlet 40. Similarly, a cross-sectional shape and area of the first duct 28 at the second end 56 corresponds to (e.g., is substantially the same as) the cross-sectional shape and area of the opening 46 at the first side 42 of the evaporator 32. In this configuration, the cross-sectional area of the first duct 28 increases from the first end 54 to the second end 56.

The second duct 30 extends vertically next to the blower 14, and includes an inner wall 58 at an interior portion of the housing 12, and an opposing outer wall 60. The second duct 30 further defines a first end 62 (i.e., inlet end, upstream end, etc.) proximate the second side 44 of the evaporator 32 and an opposing second end 64 (i.e., outlet end, downstream end, housing outlet, etc.). The housing 12 includes an outlet opening 65 at the second end 64 of the second duct 30, which is configured to output the cooled air from the housing 12 for introduction to the passenger compartment of the vehicle (e.g., through a rear door). A cross-sectional shape and area of the second duct 30 at the first end 62 corresponds to the cross-sectional shape and area of the opening 46 at the second side 44 of the evaporator 32. A cross-sectional shape and area of the second duct 30 at the second end 64 corresponds to the cross-sectional shape and area of an external duct (not shown), which is configured to fluidly connect the second end 64 of the second duct 30 to the passenger compartment. In this configuration, the cross-sectional area of the second duct 30 decreases from the first end 62 to the second end 64.

Referring now to FIG. 3, various dimensions of the system 10 are defined. Notably, as shown in FIG. 3, when the system 10 is installed, the outer wall 60 of the second duct 30 defines a substantially vertical first wall axis 66, such that the first wall axis 66 extends substantially perpendicular to the ground when the system 10 is installed in the vehicle. The outer wall 52 of the first duct 28 defines a second wall axis 68 angularly offset from the first wall axis 66 by a housing angle α. Specifically, the housing 12 defines a substantially “V” shape outer profile between the first and second wall axes 66, 68. The housing angle α is acute (e.g., between approximately 15 degrees and 45 degrees), which reduces the overall volume of the system 10, making the system 10 more compact and capable of fitting within a wheel well of the vehicle or in other compact areas of the vehicle. A lower width W_{L} is defined at a lower (e.g., lowermost) portion 72 of the housing 12. In the configuration shown in FIGS. 2-4, the width of the housing 12 measured laterally between the outer walls 52, 60 decreases moving from the blower axis 18 down to the lower portion 72, such that the lower width W_{L} is narrower than the width of the rest of the housing 12.

A drain pan 70 is disposed on the housing 12 at the lower portion 72 thereof. The drain pan 70 extends along the outer wall 52 of the first duct 28 upstream from the evaporator 32 and extends along the outer wall 60 of the second duct 30 downstream from the evaporator 32. The drain pan 70 further surrounds the lower end 45 of the evaporator 32 and is configured to collect condensation (e.g., water or other moisture) formed in either or both of the first and second ducts 28, 30, and/or the evaporator 32 while the system 10 operates. Condensation may pass through the space between each of the first and second ducts 28, 30 and the drain pan 70 or may pass through other openings for introduction to the drain pan 70. The combination of the “V” shape of the housing 12 and the position of the drain pan 70 at the lower portion 72 of the housing 12 causes the condensation to naturally collect in the drain pan 70. Importantly, the drain pan 70 pushes the condensation furthest away from the blower 14, preventing the condensation, which can be damaging to the blower 14, from traveling upstream in the first duct 28 toward the blower 14. A drain opening 74 is formed in a lowermost portion of the drain pan 70, below the lower end 45 of the evaporator 32, and is configured to output the condensation from the drain pan 70.

Referring still to FIG. 3, the system 10 is shown with a door 76 disposed in the second duct 30 in an open position. Specifically, the door 76 is disposed in one of the conduits 21, 23, which are defined in at least a portion of the second duct 30, extending upstream from the outlet opening 65. While FIG. 3 shows one door 76, it should be understood that more than one door 76 may be installed in the second duct 30. For example, a door 76 may be installed in each conduit 21, 23, such that the doors 76 separately control the volume flow rate of air flowing through each corresponding zone of the system 10. Each conduit 21, 23 may be fluidly connected at the outlet opening 65 to its own corresponding ducting for providing air to different areas of the passenger compartment. For example, one of the first or second conduits 21, 23 may be fluidly connected to a duct providing air to a rear door or other area on a driver's side of the vehicle, and the other of the first or second conduits 21, 23 may be fluidly connected to a separate duct providing air to a rear door or other area on a passenger's side of the vehicle.

While the blower 14 operates, air is provided to each of the conduits 21, 23 in the second duct 30 at the same volume flow rate. However, the doors 76 in each conduit may be separately articulated between open and closed positions to individually control the volume flow rate to different zones. For example, as a door 76 is rotated toward the closed position, the cross-sectional area between the door 76 and the walls of the corresponding conduit 21, 23 decreases, thereby restricting airflow through the conduit 21, 23. Similarly, as the door 76 is rotated toward the open position, the cross-sectional area between the door 76 and the walls of the corresponding conduit 21, 23 increases, thereby increasing airflow through the conduit 21, 23. When doors 76 in each conduit 21, 23 are rotated into substantially the same orientation (e.g., the doors are co-planar), the volume flow rate is substantially the same in each of the conduits 21, 23. However, when a first door 76 is rotated more toward the open position than a second door 76, the volume flow rate of air past the first door 76 is greater than past the second door 76. In this configuration, air may be output from each conduit 21, 23 at a different volume flow rate, providing air to different zones of the passenger compartment at different volume flow rates with the same blower speed. Furthermore, one door 76 may be positioned in the completely closed position, preventing air from flowing through the corresponding zone. In this configuration, air flow may be shut off to a specific individual zone of the passenger compartment without affecting other zones.

Referring still to FIG. 3, the door 76 defines a hub 78 and two substantially planar flaps 80 extending from opposing sides of the hub 78. As shown in FIG. 3, the flaps 80 may be offset and substantially parallel, but according to other exemplary embodiments, the flaps 80 may be substantially co-planar or may be disposed on an angle relative to each other. The hub 78 is pivotally coupled to the second duct 30 in a door portion 82 of the second duct 30, and is configured to rotate about a door axis 84 substantially parallel to the blower axis 18. This configuration further simplifies assembly of the system 10. For example, both the door 76 and the blower 14 are installed in the same direction in the first body 22 before the second body 24 is placed on the first body 22. As a result, the operator or machine assembling the system 10 does not have to reorient the housing 12 in an additional step in order to install both the blower 14 and the door 76. It should be understood that in a configuration of the system 10 with more than one door 76, each door 76 may be installed along the same door axis 84 or may define parallel door axes 84.

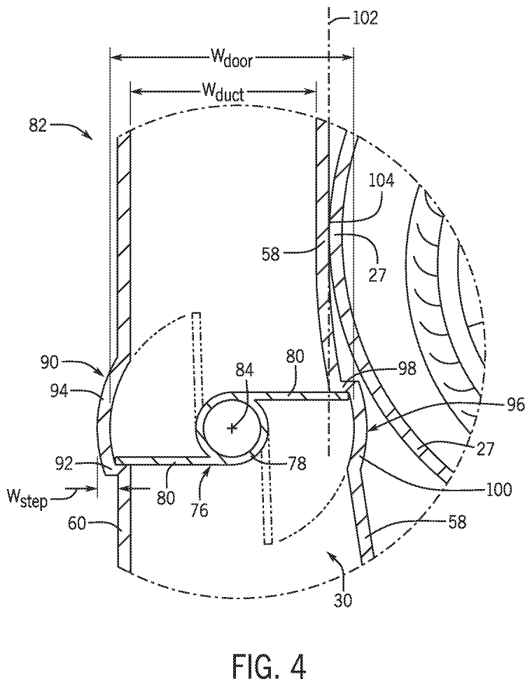

As shown in FIG. 3, a first lateral axis 86 extends substantially perpendicular to the outer wall 60 of the second duct 30 and laterally through the blower axis 18. It should be known that the term “lateral,” as used here and elsewhere in this application, refers to a direction approximately perpendicular to the outer wall 60 of the second duct 30. A second lateral axis 88 extends substantially perpendicular to the outer wall 60 and laterally through the door axis 84. The first lateral axis 86 and the second lateral axis 88 are substantially parallel, such that the door axis 84 is disposed below (e.g., by approximately 50 mm) the blower axis 18, and a portion of the door 76 is nested in the tongue 34 when the door 76 is in a closed position (shown in FIGS. 2 and 4). In this configuration, the door 76 is disposed vertically between a center of the blower 14 (e.g., the blower axis 18) and the upper end 43 of the evaporator 32. However, it should be understood that according to other exemplary embodiments, the door axis 84 may be disposed above the blower axis 18, such that the door 76 is disposed above the center of the blower 14.

Referring now to FIG. 4, the door portion 82 of the second duct 30 is shown in further detail. Specifically, the door 76 is shown in the closed position. A door width W_{door} is measured between opposing ends of the flaps 80 and is greater than a duct width W_{duct} of the second duct 30 proximate the door portion 82. The larger door width W_{door} ensures that when the door 76 is in the closed position, the flaps 80 are able to positively engage a portion of the second duct 30 to provide a secure fit and prevent air from passing between the flaps 80 and the second duct 30. An outer bulge 90 extends outward from the outer wall 60 (e.g., away from the second duct 28) and defines a step 92 (i.e., a stopper), having a step width Wₛₜₑₚ, extending substantially perpendicular to the outer wall 60 and an arc 94 extending downstream from the step 92. The arc 94 follows a circular path about the door axis 84 corresponding to the circular path defined by the flaps 80. Similarly, an inner bulge 96 extends inward from the inner wall 58 (e.g., away from the second duct 28 and into the tongue 34 toward the blower 14) and defines a step 98 (i.e., a stopper), having the same step width Wₛₜₑₚ, extending substantially perpendicular to the inner wall 58 and an arc 100 extending upstream from the step 98. The arc 100 follows a circular path about the door axis 84 corresponding to the circular path defined by the flaps 80, substantially similar to the arc 94. As shown in FIG. 4, when the door 76 is in the closed position, the flaps 80 engage the steps 92, 98, such that the steps 92, 98 are configured to constrain further rotation of the door 76 about the door axis 84.

The position of the inner bulge 96 offset from (e.g., below) the first lateral axis 86 allows for the second duct 30 to be brought closer to the blower wall 27, reducing the overall width of the housing 12. Specifically, as shown in FIG. 4, the inner wall 58 in the door portion 82 is disposed against the blower wall 27 at the first lateral axis 86, and the inner bulge 96 extends laterally inward (e.g., along the second lateral axis 88) into the tongue 34, taking advantage of a void space between the blower portion 26 and the second duct 30.

Referring to FIGS. 3 and 4, a tangential axis 102 extends tangentially to the blower wall 27 at a tangential point 104. The tangential point 104 is defined where the inner wall 58 engages the blower wall 27 or is disposed closest to the blower wall 27. At least a portion of the inner wall 58 proximate the tangential point 104 extends along the tangential axis 102. As shown in FIGS. 3 and 4, the inner bulge 96 extends away from the tangential axis 102 and toward the blower wall 27. A portion of the inner wall 58 upstream from the tangential point 104 and/or proximate the inner bulge 96 may further curve away from the tangential axis 102 and toward the blower wall 27. These configurations reduce the distance between the door axis 84 and the blower axis 18, and therefore the overall width of the housing 12. It should be noted that while FIGS. 3 and 4 show the door 76, the outer bulge 90, and the inner bulge 96 disposed below the tangential point 104, according to other exemplary embodiments, the door 76, the outer bulge 90, and the inner bulge 96 may be disposed above the tangential point 104. Similarly, the inner wall 58 may curve above the tangential point 104 away from the tangential axis 102 and toward the blower wall 27. In either configuration, the outer bulge 90 is configured to extend away from the tangential axis 102 and away from the blower wall 27.

In the configuration shown in FIGS. 3 and 4, a lateral direction may be defined as being substantially perpendicular to tangential axis 102. The first and second lateral axes 86, 88 extend in the lateral direction and therefore extend substantially perpendicular to the tangential axis 102. According to an exemplary embodiment, the first lateral axis 86 may extend from the tangential point 104, such that the blower width W_{blower} is measured perpendicularly to the tangential axis 102. It should be further understood that the tangential axis 102 may extend substantially parallel to the first wall axis 66, such that the tangential axis 102 is oriented perpendicular to the ground when the system 10 is installed in a vehicle.

Referring to FIG. 3, a housing width W_{housing} measures the widest portion of the housing 12, which is taken along the first lateral axis 86 (e.g., in the lateral direction), between the outer bulge 90 and the furthest portion of the blower wall 27. A blower width W_{blower} is also measured along the first lateral axis 86 (e.g., in the lateral direction) between opposing sides of the blower wall 27. The blower width W_{blower} may further be the widest portion of the blower portion 26. Due to the placement of the inner bulge 96 in the tongue 34, the housing width W_{housing} is less than the blower width W_{blower} plus the door width W_{door}, reducing the overall housing width W_{housing} by at least the step width Wₛₜₑₚ of the inner bulge 96 to further compact the system 10 for placement in the vehicle.

Advantageously, the compact width of the housing 12 makes it possible to install the system 10 in a rear portion of the vehicle, where space is more limited. For example, the system 10 may be installed in a wheel well or in another portion of the vehicle behind the second row of seats and proximate the rear door. For example, the outlet opening 65 may be disposed proximate a rear door jamb and be configured to fluidly engage a duct disposed in the door when the door is in a closed position. In this configuration, the system 10 is located in the car closer to the vents in the rear of the vehicle (e.g., in each of the rear doors), improving the operational efficiency of the system 10 relative to a system 10 located in a forward portion of the vehicle.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is to be understood that although the present invention has been described with regard to preferred embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, dimensions, structures, shapes and proportions of the various elements, mounting arrangements, orientations, manufacturing processes, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A vehicle HVAC system, comprising:
an evaporator;
a blower disposed above the evaporator;
a duct passing next to the blower, the duct connecting the evaporator and an outlet opening;
wherein the duct is approximately vertical; and
wherein a width of the system proximate a lower end of the duct is narrower than a width of the system proximate the blower.

2. The system of claim 1, further comprising:
a tongue disposed along the blower; and
a drain pan defined in a lower end of the system, the drain pan configured to collect water from at least one of the duct or the evaporator.

3. The system of claim 2, wherein a drain opening is disposed in the drain pan and is configured to output condensation water from the drain pan.

4. The system of claim 3, wherein an upper end of the evaporator is positioned in the tongue, and wherein a lower end of the evaporator is positioned above the drain.

5. The system of claim 1, further comprising:
a door disposed in the duct;
wherein the door is located vertically between a center of the blower and an upper end of the evaporator.

6. The system of claim 5, further comprising:
a step formed in an inner wall of the duct and configured to constrain rotation of the door;
wherein the stopper extends from the duct toward the blower.

7. The system of claim 1, further comprising:
a housing comprising:
a first portion forming a flow path for air output from the blower;
a second portion extending upstream from the evaporator between the first portion and the evaporator; and
a third portion extending downstream from the evaporator;
wherein the duct is defined by the second and third portions of the housing; and
wherein the evaporator and the blower are disposed in the housing.+

8. A housing for a vehicle HVAC system, comprising:
a blower portion defined by a blower wall and configured to receive a blower therein along a blower axis, the blower portion defining a blower width;
a first duct extending downstream from the blower portion;
a second duct extending downstream from the first duct and defining an inner wall and an opposing outer wall; and
an inner bulge extending from the inner wall and defining a step;
wherein the inner wall of the second duct extends tangentially to the blower wall along a tangential axis; and
wherein the inner bulge extends away from the tangential axis and toward the blower wall.

9. The housing of claim 8, further comprising a door disposed in the duct and configured to rotate about a door axis parallel to the blower axis; and
wherein the door is configured to engage the step of the inner bulge when the door is in a closed position.

10. The housing of claim 9, wherein:
the door comprises a hub and a pair of opposing flaps defining a door width;
the blower portion defines a blower width measured in a lateral direction between opposing portions of the blower wall;
a housing width is a widest width of the housing measured in the lateral direction across the housing; and
the housing width is less than the door width plus the blower width.

11. The housing of claim 10, wherein the lateral direction is perpendicular to the tangential axis.

12. The housing of claim 10, further comprising an outer bulge extending from the outer wall away from the tangential axis and defining a step configured to be engaged by the door when the door is in a closed position.

13. The housing of claim 12, wherein the housing width is measured between the outer bulge and the furthest portion of the blower wall.

14. The housing of claim 8, wherein the first duct defines an inner wall and an opposing outer wall;
wherein the outer wall of the second duct defines a first wall axis; and
wherein the outer wall of the first duct defines a second wall axis angularly offset from the first axis, such that the outer walls define a substantially “V” shape.

15. The housing of claim 14, wherein the system is configured to be disposed in a vehicle with the first wall axis substantially perpendicular to the ground.

16. The housing of claim 14, further comprising a tongue formed from the blower wall and extending circumferentially around the blower axis;
a tongue end defined at an end of the tongue; and
a blower outlet defined between the tongue end and the outer wall of the first duct, the blower outlet configured to output air from the blower portion to the first duct.

17. The housing of claim 8, further comprising an evaporator disposed between the first duct and the second duct.

18. The housing of claim 17, wherein the housing does not include a heater.

19. The housing of claim 8, further comprising a drain pan disposed on a lower portion of the housing, the drain pan configured to collect condensation from the housing.

20. The housing of claim 19, further comprising a drain outlet formed in a lowermost portion of the drain pan and configured to output the condensation from the drain pan.
